(19) United States
(12) Patent Application Publication
(10) Pub. No.: US 2002/0024778 A1
(43) Pub. Date: Feb. 28, 2002

(54) Spin valve films with improved cap layers

(76) Inventors: Song Sheng Xue, San Jose, CA (US); Xuefei Tang, Eden Prairie, MN (US); Qing He, Bloomington, MN (US); Steven Paul Bozeman, Savage, MN (US); Patrick Joseph Ryan, St. Paul, MN (US)

Correspondence Address: MERCHANT & GOULD PC, P.O. BOX 2903, MINNEAPOLIS, MN, 55402-0903, US

(21) Appl. No.: 09/809,653

(22) Filed: Mar. 15, 2001

Related U.S. Application Data
(60) Provisional application No. 60/194,812, filed on Apr. 5, 2000.

(51) Int. Cl. G11B 5/39

(52) U.S. Cl. 360/324.1; 360/314

(57) ABSTRACT

The invention includes spin valve sensors. The spin valve sensors of the invention can be dual spin valves, bottom pinned spin valves, or top pinned spin valves. Spin valve sensor in accordance with the invention include a cap layer of tantalum nitride and a free layer. Cap layers of the invention include both monolayers and bilayers. Monolayer cap layers are tantalum nitride, and bilayer cap layers are a first layer of tantalum nitride with a layer of copper, ruthenium, gold, or silver thereon.

### FIELD OF THE INVENTION

This invention relates generally to magnetic transducers for reading information from a magnetic medium and, in particular, to a spin valve magnetoresistive read sensor having a cap layer of specific composition, the spin valve having enhanced device properties and function.

### BACKGROUND OF THE INVENTION

Computers often include auxiliary memory storage devices having media on which data can be written and from which data can be read for later use. A direct access storage device (disk drive) incorporating rotating magnetic disks is commonly used for storing data in magnetic form on the disk surfaces. Data is recorded on concentric, radially spaced tracks on the disk surfaces. Magnetic heads including read sensors are then used to read data from the tracks on the disk surfaces.

In high capacity disk drives, magnetoresistive read sensors, commonly referred to as MR heads, are the prevailing read sensors because of their capability to read data from a surface of a disk at greater linear densities than thin film inductive heads. An MR sensor detects a magnetic field through the change in the resistance of its MR sensing layer (also referred to as an “MR element”) as a function of the strength and direction of the magnetic flux being sensed by the MR layer.

One type of MR sensor currently under development is the giant magnetoresistive (GMR) sensor manifesting the GMR effect. In the GMR sensors, the resistance of the MR sensing layer varies as a function of the spin-dependent transmission of the conduction electrons between the magnetic layers separated by a non-magnetic layer (spacer) and the accompanying spin-dependent scattering, which takes place at the interface of the magnetic and non-magnetic layers and within the magnetic layers.

GMR sensors using only two layers of ferromagnetic material (e.g., Ni—Fe or Co or Ni—Fe/Co) separated by a layer of non-magnetic metallic material (e.g., copper) are generally referred to as spin valve (SV) sensors manifesting the SV effect. In an SV sensor, one of the ferromagnetic layers, referred to as the pinned layer, typically has its magnetization pinned by exchange coupling with an antiferromagnetic (e.g., Fe—Mn or NiO) layer. The pinning field generated by the antiferromagnetic layer should be greater than demagnetizing fields to ensure that the magnetization direction of the pinned layer remains fixed during application of external fields (e.g., fields from bits recorded on the disk). The magnetization of the other ferromagnetic layer, referred to as the free layer, however, is not fixed and is free to rotate in response to the field from the disk.

Two important considerations in the development of spin valves are protection of the structure of the valve during and after production and increasing the GMR of the valve. The cap or capping layer may have a large impact on both of these functions. One example of a spin valve is taught by Lee et al., U.S. Pat. No. 6,141,191, which discloses a spin valve having a protective cap comprised of a material such as tantalum, nickel, iron, chromium or alumina. Similarly, Lin, U.S. Pat. No. 6,033,491 discloses a cap layer composed of tantalum that is sputter deposited on the stack and then later removed.

Even with the structures disclosed in these recent publications, there still exists a need for improved processes and structures that offer structural protection of the spin valve and provide enhanced GMR.

### SUMMARY OF THE INVENTION

The invention relates to a spin valve type magnetoresistive sensor having electrical resistance that changes with the magnetization direction of a pinned magnetic layer and the magnetization direction of a free magnetic layer affected by an external magnetic field. More particularly, the invention provides a spin valve sensor containing tantalum nitride or copper/tantalum nitride as the cap layer, which has a higher sensitivity of detection, sufficient pinning strength, good soft magnetic properties in the free layer, as well as good protective properties against oxidation and corrosion during wafer processing.

The cap layer used in spin valve sensors not only functions as protection against oxidation and corrosion during wafer processing, but also functions as the electron scattering layer. Commonly used materials for the cap layer include tantalum (Ta) or nickel—iron—chrome (NiFeCr) for example. These cap layers have little resistance to corrosion and/or oxidation. These materials also do not function well as an electron scattering layer in a bottom pinned spin valve (BSV) sensor.

By using tantalum nitride (TaN), or a bilayer of copper/tantalum nitride (Cu/TaN) as the cap layer, the spin valves of the invention possess high sensitivity and good soft magnetic properties. Compared to spin valves with a tantalum cap layer, the DR/R of spin valves in accordance with the invention is increased by more than 15%. Compared to spin valves with a NiFeCr cap layer, the DR/R of spin valves of the invention is increased by more than 40%. Tantalum nitride, or copper/tantalum nitride can be used in the cap layer in conjunction with different antiferromagnetic (AFM) materials like PtMn, NiMn, IrMn, PdPtMn, CrMnPt, CrMnCu, CrMnPd, PtRuMn to increase the sensitivity of the spin valve. The invention is applicable to top, dual, and bottom spin valve sensors.

### BRIEF DESCRIPTION OF THE DRAWINGS

FIG. 1 depicts a dual spin valve (DSV) in accordance with one aspect of the invention.

FIG. 2 depicts a bottom pinned spin valve (BSV) in accordance with one aspect of the invention.

FIG. 3 depicts a top pinned spin valve (TSV) in accordance with one aspect of the invention.

FIG. 4 illustrates DR and DR/R for bottom spin valves (BSVs) with different cap layers.

FIG. 5 illustrates interlayer coupling fields for bottom spin valves (BSVs) with different cap layers.

FIG. 6 illustrates DR/R of a bottom pinned spin valve (BSV) with copper/tantalum nitride as the cap layer as the applied field (oriented parallel to the pinning field direction) is varied.

FIG. 7 illustrates DR/R of a dual spin valve (DSV) with tantalum nitride as the cap layer as the applied field (oriented parallel to the pinning field direction) is varied.

### DETAILED DESCRIPTION OF THE PREFERRED EMBODIMENTS

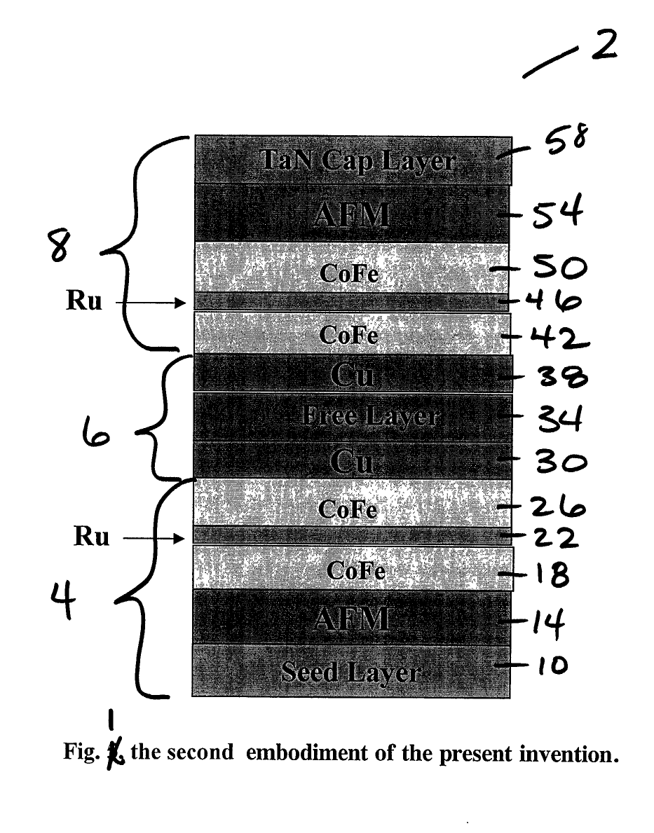

In accordance with the invention, there is provided an electromagnetic component, which may be used to read information from magnetic information storage media. One embodiment of the invention may be seen in FIG. 1. Generally the components of the invention are referred to as a spin valve. A spin valve is an electromagnetic component used in computer disk drives. The invention provides spin valves having a cap layer that provides enhanced physical protection and increased electron scattering.

THE SPIN VALVE

As can be seen, FIG. 1, one exemplary embodiment of the spin valve or stack 2 of the invention comprises multiple layers of ferromagnetic and antiferromagnetic materials. FIG. 1 depicts an exemplary dual spin valve 2 having a cap layer 58.

Turning first to the lower portion 4 of the stack 2, the lower layer 10 of the stack 2 functions to seed the deposition of the other layers that are subsequently deposited on the stack 2. To this end, the seed layer 10 functions as a substrate and provides structural or textural orientation to the layers deposited subsequently. Generally the seed layer 10 may comprise any metal or metal alloy. Exemplary metals include nickel (Ni), chromium (Cr), tantalum (Ta), titanium (Ti), manganese (Mn), copper (Cu), tungsten (W), platinum (Pt), gold (Au), silver (Ag) or alloys of these metals. The seed layer 10 may be a mono- or bi-layer structure.

Generally, the thickness of the seed layer 10 may range from about 30 to 100 angstroms and preferably is about 50 angstroms in single or multiple layers. The composition of the seed layer 10 is preferably an alloy of nickel, iron and chrome, in a ratio of about 48:12:40, respectively in the first layer. With the second layer being nickel and iron at a respective ration of 85:15. Another preferred metal useful as a seed layer 10 is tantalum.

Antiferromagnetic layer 14, or AFM layer functions to set the magnetic orientation of the lower portion 4 of the stack 2. Generally, antiferromagnetic layer 14 is a metal oxide or metal alloy of platinum, manganese, nickel, chromium, iridium (Ir), rhodium (Rh), paladium (Pd), copper, ruthenium (Ru), and iron among other metals. Preferably, antiferromagnetic layer 14 comprises an alloy of platinum and manganese with generally a ratio of about 50 to 50, which is sputter deposited to a thickness of about 50 to 300 angstroms, preferably about 150 angstroms.

Pinned layer 18 functions to provide a fixed magnetic orientation to the lower portion 4 of the stack 2 and acts along with reference layer 26 to provide the fixed orientation of the entire spin valve stack. The magnetic orientation of the pinned layer 18 is fixed, (or pinned), by the antiferromagnetic layer 14. Generally, the pinned layer 18 may comprise any number of highly magnetic metals or metal alloys such as cobalt, iron, nickel, chromium, platinum, or tantalum among others. Preferably, pinned layer 18 comprises an alloy of cobalt and iron at a preferred ratio of about 90 to 10. The pinned layer 18 may be sputter deposited through processes known in the art to a thickness of from about 10 to 40 angstroms, preferably about 15 to 30 angstroms.

Artificial exchange layer 22 functions as an intermediate layer between pinned layer 18 and reference layer 26. Generally, artificial exchange layer 22 provides a medium for antiferromagnetic coupling between pinned layer 18 and reference layer 26. The exchange layer 22 may comprise any material that has properties of nonmagnetic metals such as copper, chromium, silver, gold, ruthenium, rhodium or alloys thereof. Preferably, the exchange layer 22 comprises ruthenium which has been sputter deposited to a thickness of about 5 to 15 angstroms, preferably about 9 angstroms.

Reference layer 26 has a composition and thickness substantially similar to pinned layer 18 and functions to provide the fixed orientation of the spin valve stack 2. In order to function as a spin valve, the reference layer 26 has a magnetic orientation that is opposite to the magnetic orientation of the pinned layer 18 (as a result of the antiferromagnetic coupling). This allows for the orientation of layer 26 to be fixed.

Alternatively, exchange layer 22 and reference layer 26 may be eliminated from the stack. In this embodiment, pinned layer 18 still functions to fix the magnetic orientation of the stack 2, and accomplishes it with a lower net magnetism, allowing for higher sensitivity of the stack 2.

The intermediate portion 6 of the stack 2 functions to separate the lower 4 and upper 8 portions of the stack 2 and to function as the free layer of the spin valve 2. Generally, the intermediate portion 6 of the stack 2 comprises one or more spacer layers 30, 38 and one or more free layers 34.

The spacer layers, 30 and 38 function to isolate or insulate the free layer 34 from the pinned 18 and reference layers 26 in the respective upper 8 and lower 4 portions of the stack 2. To this end, the spacer layers, 30 and 38 may comprise any non-magnetic electrically conductive material that magnetically insulates the free layer 34. Spacer layers 30 and 38 comprise any nonmagnetic materials such as copper, silver, gold and alloys thereof. One preferred material for the spacer layers 30 and 38 is copper or alloys of copper that may be sputter deposited under low power to a thickness of about 15 to 35 angstroms, preferably about 20 angstroms.

The free layer 34 may be comprised of a single—or multiple layers. Generally, the free layer 34 functions to monitor an externally applied magnetic field. Accordingly, when the stack 2 is biased, the free layer 34 will follow the orientation of the resulting magnetic field. The free layer 34 may comprise any material that is a soft magnetic material such as nickel, cobalt, iron, and alloys thereof. Preferably, the free layer 34 comprises a mono- or tri-layer, which comprises cobalt, iron, nickel or combinations thereof. Most preferably, the free layer 34 is a tri-layer that begins with a cobalt iron layer in a ratio of about 90:10, a second layer of nickel and iron in a ratio of about 85:15, and a final cobalt iron layer in a ratio of about 90:10. The free layer 34 may be deposited through sputtering to a thickness of about 10 to 150 angstroms, preferably about 20 to 30 angstroms.

Turning to the upper portion 8 of this embodiment of the invention, reference layer 42, exchange layer 46, and pinned layer 50 may be composed of the same or similar materials and fabricated in the same or a similar manner as pinned layer 18, exchange layer 22, and reference layer 26 in the lower portion 4 of this embodiment of the invention. Reference layer 42, exchange layer 46, and pinned layer 50 of the upper portion 8 of this embodiment of the invention function in a similar or the same manner as those in the lower portion 4 of the stack 2 with the magnetic orientation of pinned layer 50 being set by antiferromagnetic layer 54. Here again, antiferromagnetic layer 54 may be composed of the same or similar materials as antiferromagnetic layer 14 in the lower portion 4 of the stack 2.

THE CAP LAYER

The cap layer 58 functions to structurally protect the stack 2 both during fabrication and during operation. During fabrication, the various layers of the stack 2 may be subjected to oxidation and corrosion. Further, once fabricated, the stack 2 may be subjected to physical contact. The cap layer of the invention functions to protect the stack 2 of the invention against these concerns.

Generally, the cap layer 58 is nonmagnetic so as not to affect the electromagnetic operation of the stack 2. In accordance with the invention the use of several preferred materials provides a cap layer 58, which not only enhances device performance but also physically protects the stack 2 before, during and after processing. Preferably, the cap layer 58 reduces corrosion, oxidation and enhances the scattering of electrons.

To this end, the cap layer 58 may comprise one or more layers, preferably either a monolayer or a bilayer. In one preferred embodiment, a monolayer of tantalum nitride may be used as a cap layer 58. Generally, the ratio of tantalum to nitride in the cap layer 58 ranges from about 30:70 to 70:30, and preferably is about 50:50. The thickness of the cap layer 58 ranges from about 20 to 200 angstroms and preferably is 50 to 70 angstroms.

In a second preferred embodiment, the cap layer 58 may be a bilayer of tantalum nitride with a second layer of copper, ruthenium, gold, or silver. In this embodiment, the thickness of the tantalum nitride layer generally ranges from about 20 to 200 angstroms, and preferably from about 50 to 70 angstroms. The second layer of the bilayer ranges in thickness from about 3 to 20 angstroms, and preferably about 5 to 10 angstroms. The cap layer 58 may be sputter deposited to a thickness of about 20 to 220 angstroms, preferably about 60 angstroms.

In either embodiment, the materials are preferably sputter deposited at ambient temperatures in a nitrogen/noble gas atmosphere. The amount of nitrogen in the atmosphere depends on the particular ratio of tantalum to nitride that is desired. Preferably, the nitrogen has a partial pressure of about 0.6 mTorr at a total pressure of about 4 mTorr. The sputter power uses ranges of about 50 W to 500 W, and preferably about 100 W.

Once the cap layer 58 is deposited, the stack 2 of the invention may then be annealed if desired or necessary. Any known process of annealing may be utilized to fabricate a device 2 of the invention. The step of annealing is undertaken while a magnetic field of greater than about 0.5 Tesla, preferably about 1 Tesla, is applied. Preferably, the annealing is done at a temperature of about 230° C. to about 350° C. for about 1 to 10 hours.

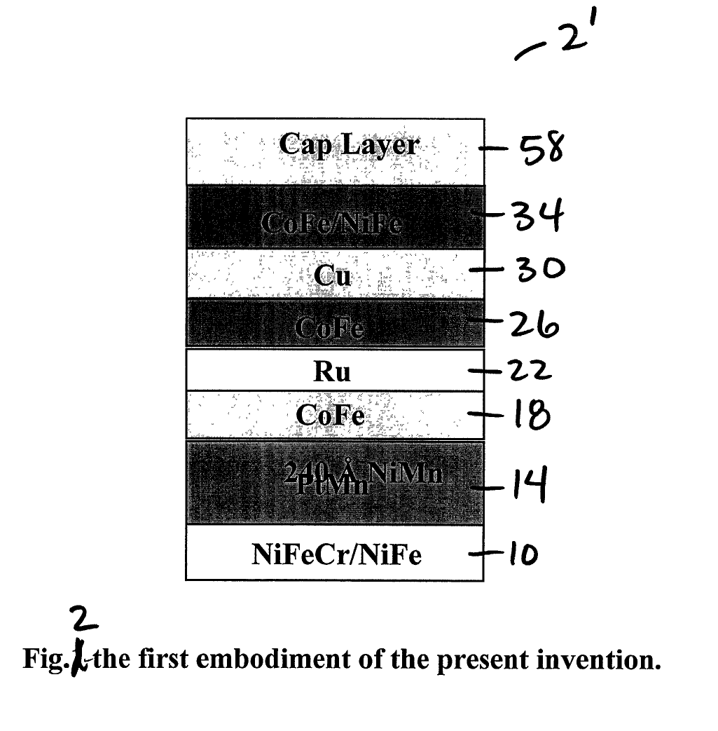

A further exemplary embodiment of the invention may be seen in FIG. 2. This embodiment of the invention is a bottom pinned spin valve sensor using cap layer 58. This stack 2′ uses antiferromagnetic layer 14 to fix or pin the direction of the magnetic field in layer 18. Pinned layer 18 then works in conjunction with exchange layer 22 and reference layer 26 in the same manner as described earlier. Free layer 34 is insulated from the pinned 18 and reference 26 layers by spacer layer 30.

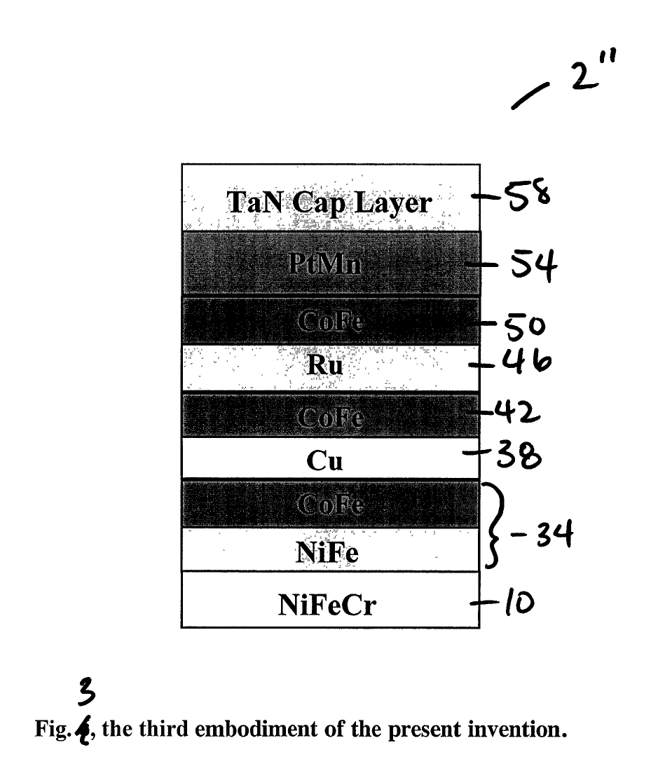

Another exemplary embodiment of the invention is illustrated in FIG. 3, which depicts a top pinned spin valve (TSV) sensor 2″ using cap layer 58. In this embodiment, the free layer 34 is a bilayer of cobalt-iron and nickel-iron, which is insulated from the pinned 50 and reference 42 layers by spacer layer 38. In this instance, the magnetic field of the pinned layer 50 is fixed by the antiferromagnetic layer 54, which is positioned below cap layer 58. Both of these embodiments perform similarly with a cap layer 58 in accordance with the invention deposited.

### Working Examples

The following experimental examples illustrate the properties and application of the invention.

Example 1: Properties of spin valves with different cap layers

A set of six spin valve stacks were prepared such as those shown in FIG. 2 using the processes of the invention. The cap layers varied across the six stacks as follows:

| Stack | Cap Layer Material |
|---|---|
| 1 | nickel-iron-chromium |
| 2 | tantalum |
| 3 | nickel-iron-chrome/tantalum nitride |
| 4 | copper/tantalum |
| 5 | tantalum nitride |
| 6 | copper/tantalum nitride |

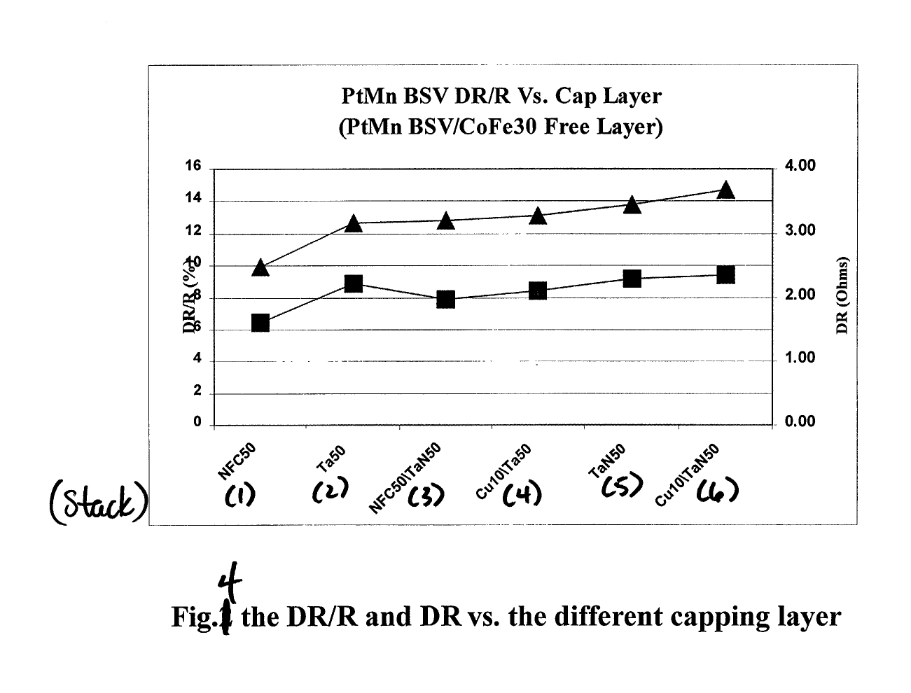

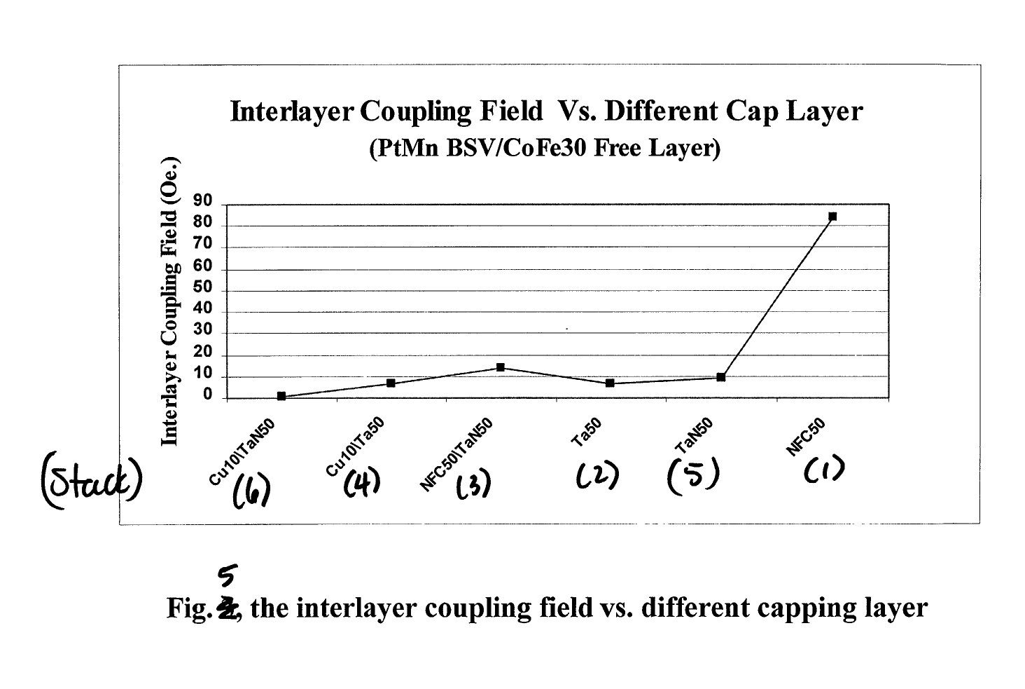

FIG. 4 shows the DR/R and DR of stacks 1 through 6. Stacks 5 and 6 have DR/R that is greatly increased (by more than 15%) when compared to stack 1. Stacks 5 and 6 also have a DR/R ratio that is 40% greater than the stack capped with nickel iron chromium (Stack 1). As can be seen in FIG. 5, Stack 6, a stack in accordance with the invention, has the smallest interlayer coupling field, while stack 2 (a stack as seen in the prior art) has the largest interlayer coupling field.

Example 2: Response of BSV and DSV with cap layers of the invention

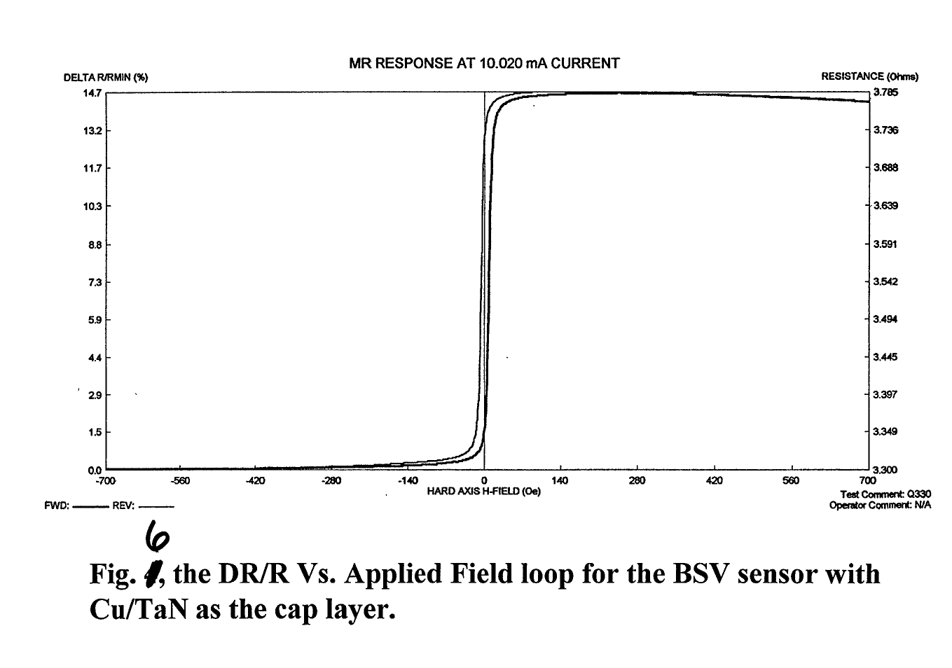

A bottom pinned spin valve using a platinum manganese pinned layer capped with copper/tantalum nitride provided a cap layer with superior protective properties against oxidation and corrosion during fabrication. FIG. 6 shows DR/R versus the applied field (oriented parallel to the pinned field) for this bottom spin valve (BSV) sensor with a copper/tantalum nitride cap layer.

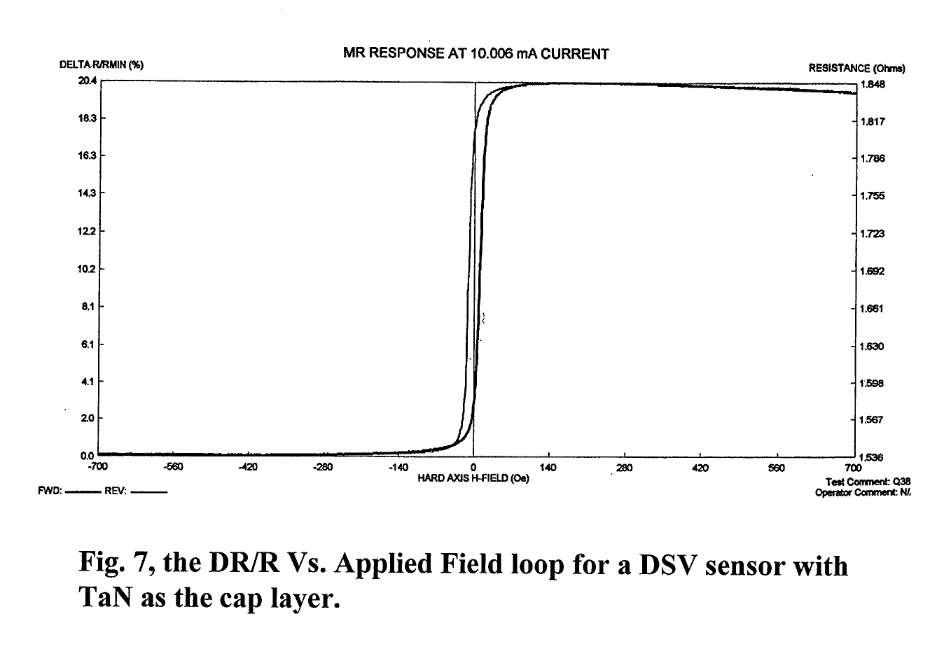

Fabrication of a dual spin valve (DSV) using a platinum manganese pinned layer capped with tantalum nitride was also undertaken. FIG. 7 shows the DR/R versus applied field loop (oriented parallel to the pinned field) for a dual spin valve with a tantalum nitride cap layer. This conformation also provided a spin valve with a cap layer with superior protective properties against oxidation and corrosion during fabrication

Example 3: HGA results of stacks in accordance with the invention

Table 1 illustrates Head Gimbal Assembly (HGA) results from ten recording heads tested at HGA level. The heads were tested at 10 K revolutions per minute.

| | Low | High | | |
|---|---|---|---|---|
| | Frequency | Frequency | Read Width- | Write Width- |
| Head | Amplitude | Amplitude | microinch | microinch |
| Number | (LFA)-Avg. | (HFA)-Avg. | (μin) | (μin) |
| 1 | 1938.819 | 1385.695 | 4.272 | 21.033 |
| 2 | 1576.31 | 1106.522 | 3.931 | 20.938 |
| 3 | 1556.521 | 1052.535 | 3.785 | 18.099 |
| 4 | 1500.86 | 1124.557 | 4.866 | 18.896 |
| 5 | 2512.281 | 2137.324 | 6.411 | 23.38 |
| 6 | 2292.966 | 1672.081 | 4.558 | 20.016 |
| 7 | 2493.438 | 1534.303 | 3.987 | 18.533 |
| 8 | 2564.118 | 1869.627 | 4.036 | 19.236 |
| 9 | 2183.145 | 1743.639 | 5.068 | 21.7 |
| 10 | 2785.398 | 2681.147 | 4.948 | 22.736 |
| AVERAGE | 2140.386 | 1630.743 | 4.5862 | 20.4567 |
| STDEV | 470.5024 | 512.7484 | 0.78907116 | 1.802157 |

The normalized low frequency amplitude/micrometer (LFA/μm) was 6-7 millivolts/micrometer (mv/μm).

The above specification, examples and data provide a complete description of manufacture and use of the composition of the invention. Since many embodiments of the invention can be made without departing from the spirit and scope of the invention, the invention resides in the claims hereinafter appended.

The claimed invention is:

1. A spin valve sensor, said spin valve sensor comprising a cap layer and a free layer, said cap layer comprising tantalum nitride.

2. The spin valve sensor of claim 1, wherein said spin valve sensor cap layer is a monolayer.

3. The spin valve sensor of claim 1, wherein said spin valve sensor cap layer comprises a bilayer.

4. The spin valve sensor of claim 3, wherein said cap layer bilayer comprises a first layer and a second layer.

5. The spin valve sensor of claim 4, wherein said bilayer second layer comprises a metal selected from the group of ruthenium, gold, silver, copper and mixtures thereof, and said bilayer first layer comprises tantalum nitride.

6. The spin valve of claim 4, wherein said second layer comprises copper.

7. The spin valve of claim 5, wherein said first layer of said bilayer lies adjacent said free layer.

8. The spin valve of claim 1, wherein said spin valve comprises a first pinned layer and a second pinned layer.

9. The spin valve of claim 8, wherein said cap layer comprises tantalum nitride.

10. The spin valve sensor of claim 2, wherein said cap layer has a thickness of from about 20 to 200 angstroms.

11. The spin valve sensor of claim 3, wherein said cap layer has a thickness of from about 20 to 220 angstroms.

12. The spin valve sensor of claim 4, wherein said bilayer first layer has a thickness of from about 20 to 200 angstroms, and said bilayer second layer has a thickness of from about 3 to 20 angstroms.

13. The spin valve sensor of claims 1 or 4, wherein said spin valve sensor is a bottom pinned spin valve.

14. The spin valve sensor of claims 1 or 4, wherein said spin valve sensor is a top pinned spin valve.

15. The spin valve sensor of claims 1 or 4, wherein said spin valve sensor is a dual spin valve.

16. A dual pinned spin valve sensor comprising:
(a) a seed layer comprising nickel, chromium, tantalum, titanium, manganese, copper, tungsten, platinum, gold, silver, or mixtures thereof;
(b) an antiferromagnetic layer, positioned on top of said seed layer, comprising platinum, manganese, nickel, chromium, iridium, rhodium, paladium, copper, ruthenium, iron, or mixtures thereof;
(c) a pinned layer, positioned on top of said antiferromagnetic layer, comprising cobalt, iron, nickel, chromium, platinum, tantalum, or mixtures thereof;
(d) a spacer layer, positioned on top of said pinned layer, comprising copper, silver, gold, or mixtures thereof;
(e) a free layer, positioned on top of said spacer layer, comprising nickel, cobalt, iron, or mixtures thereof;
(f) a second pinned layer, positioned on top of said free layer, comprising cobalt, iron, nickel, chromium, platinum, tantalum, or mixtures thereof;
(g) a second antiferromagnetic layer, positioned on top of said second pinned layer, comprising platinum, manganese, nickel, chromium, iridium, rhodium, paladium, copper, ruthenium, iron, or mixtures thereof; and
(h) a cap layer, positioned on top of said second antiferromagnetic layer, comprising tantalum nitride.

17. A bottom pinned spin valve sensor comprising:
(a) a seed layer comprising nickel, chromium, tantalum, titanium, manganese, copper, tungsten, platinum, gold, silver, or mixtures thereof;
(b) an antiferromagnetic layer, positioned on top of said seed layer, comprising platinum, manganese, nickel, chromium, iridium, rhodium, paladium, copper, ruthenium, iron, or mixtures thereof;
(c) a pinned layer, positioned on top of said antiferromagnetic layer, comprising cobalt, iron, nickel, chromium, platinum, tantalum, or mixtures thereof,
(d) a spacer layer, positioned on top of said pinned layer, comprising copper, silver, gold, or mixtures thereof;
(e) a free layer, positioned on top of said spacer layer, comprising nickel, cobalt, iron, or mixtures thereof; and
(f) a cap layer, positioned on top of said free layer, comprising tantalum nitride.

18. A top pinned spin valve sensor comprising:
(a) a seed layer comprising nickel, chromium, tantalum, titanium, manganese, copper, tungsten, platinum, gold, silver, or mixtures thereof;
(b) a free layer, positioned on top of said seed layer, comprising nickel, cobalt, iron, or mixtures thereof; and
(c) a spacer layer, positioned on top of said free layer, comprising copper, silver, gold, or mixtures thereof;
(d) a pinned layer, positioned on top of said spacer layer, comprising cobalt, iron, nickel, chromium, platinum, tantalum, or mixtures thereof;
(e) an antiferromagnetic layer, positioned on top of said seed layer, comprising platinum, manganese, nickel, chromium, iridium, rhodium, paladium, copper, ruthenium, iron, or mixtures thereof; and
(f) a cap layer, positioned on top of said antiferromagnetic layer, comprising tantalum nitride.

19. The spin valve sensor of claims 16, 17, or 18, wherein said cap layer comprises a monolayer of tantalum nitride

20. The spin valve sensor of claims 16, 17, or 18, wherein said cap layer comprises a bilayer having a first layer comprising tantalum nitride and a second layer comprising copper.

21. A disc drive comprising the spin valve sensor of claims 1, 16, 17, or 18.
